(19) United States
(12) Patent Application Publication
(10) Pub. No.: US 2009/0309815 A1
(43) Pub. Date: Dec. 17, 2009

(54) FLEXIBLE REFLECTIVE DISPLAY DEVICE

(76) Inventors: Jong-Seong Kim, Seoul (KR); Woo-Jae Lee, Yongin-si (KR); Neerja Saran, Suwon-si (KR)

Correspondence Address: Haynes and Boone, LLP;IP Section, 2323 Victory Avenue, SUITE 700, Dallas, TX, 75219, US

(21) Appl. No.: 12/401,502

(22) Filed: Mar. 10, 2009

(30) Foreign Application Priority Data
Jun. 16, 2008 (KR) 10-2008-0056443

(51) Int. Cl. G09G 3/30

(52) U.S. Cl. 345/76

(57) ABSTRACT

A flexible reflective display device capable of improving display quality by using a reflective electrode employing carbon nanotubes. In an exemplary embodiment, a flexible reflective display device includes a substrate, a thin film transistor, a first electrode, an electrophoretic layer and a second electrode layer. The thin film transistor is provided on the substrate. The first electrode includes carbon nanotubes and is electrically connected to the thin film transistor to display black color by reflecting external light.

### CROSS-REFERENCE TO RELATED APPLICATION

This application claims priority to Korean Patent Application No. 2008-56443 filed on Jun. 16, 2008, the contents of which are herein incorporated by reference in their entirety.

### BACKGROUND

1. Field of the Invention

The present invention relates to electronic displays. More particularly, the present invention relates to a flexible reflective display device.

2. Description of the Related Art

An electrophoretic display (EPD) is a flat panel display apparatus used in applications such as electronic books. Typically, EPDs display images via an electrophoretic phenomenon, in which an electromagnetic field is applied to conductive materials to provide the conductive materials with motility. To this end, the electrophoretic display includes two substrates each having electrodes formed thereon, with a solution containing charged pigment particles interposed between the two substrates. The two substrates are placed so that their respective electrodes face each other, and a voltage is applied across the electrodes of the two substrates, to generate a potential difference between the two. Depending on the polarity of the voltage between opposing electrodes, the charged pigment particles will migrate toward the substrate nearer or farther from the viewer, thus generating light or dark areas, respectively. These light and dark areas are placed so as to form the desired image.

In general, the electrophoretic display has high reflectivity and high contrast ratio, and is not affected by a viewing angle. In addition, the electrophoretic display typically displays the image by reflecting external light without using a backlight unit, and maintains the image even if voltage is not continuously applied thereto, thereby reducing power consumption.

Charged pigment particles having various sizes and colors (e.g., white and black) are arranged in the electrophoretic display to reflect external light. However, when the electrophoretic display displays a black image, white pigment particles interspersed between the black pigment particles may act to reduce contrast ratio. Ongoing efforts thus exist to improve the readability and contrast ratio of EPDs.

### SUMMARY

An exemplary embodiment of the present invention provides a flexible reflective display device capable of improving display quality by using a reflective electrode employing carbon nanotubes.

In an exemplary embodiment of the present invention, a flexible reflective display device includes a substrate, a thin film transistor, a first electrode, an electrophoretic layer and a second electrode layer. The thin film transistor is provided on the substrate. The first electrode includes carbon nanotubes and is electrically connected to the thin film transistor to display black color by reflecting external light.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view showing an exemplary embodiment of a flexible reflective display device according to the present invention;

FIG. 2 is a sectional view showing a part of the flexible reflective display device shown in FIG. 1;

FIG. 3 is a partially-enlarged view showing a part of a pixel electrode shown in FIG. 1; and

FIG. 4 is a sectional view showing the pixel electrode shown in FIG. 3.

### DESCRIPTION OF THE EMBODIMENTS

Hereinafter, a flexible reflective display device according to embodiments of the present invention will be explained in detail with reference to the accompanying drawings. Objects to be solved by the invention, means to solve the objects, and effects thereof will be readily understood to those skilled in the art through embodiments described with reference to accompanying drawings. However, the scope of the present invention is not limited to such embodiments and the present invention may be realized in various forms. The embodiments to be described below are nothing but the ones provided to bring the disclosure of the present invention to perfection and assist those skilled in the art to completely understand the present invention. The present invention is defined only by the scope of the appended claims. In addition, the size of layers and regions shown in the drawings can be simplified or magnified for the purpose of clear explanation. Also, the same reference numerals are used to designate the same elements throughout the drawings.

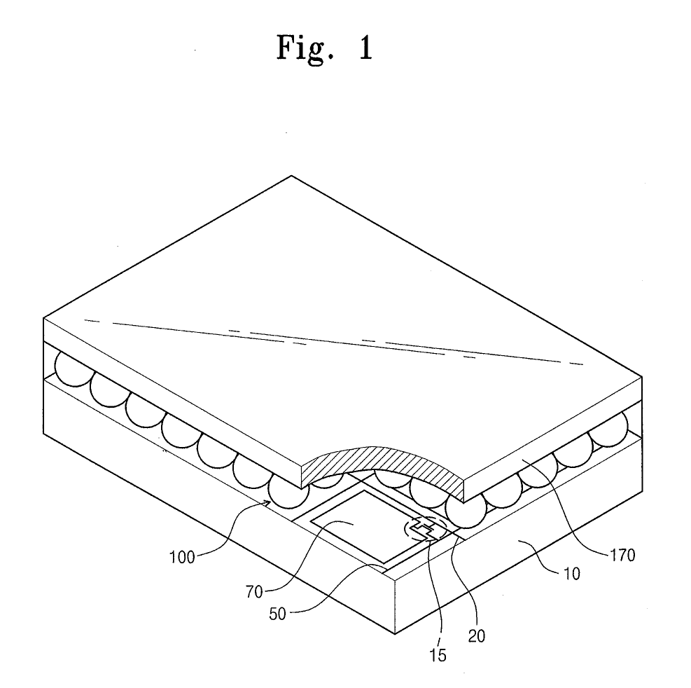

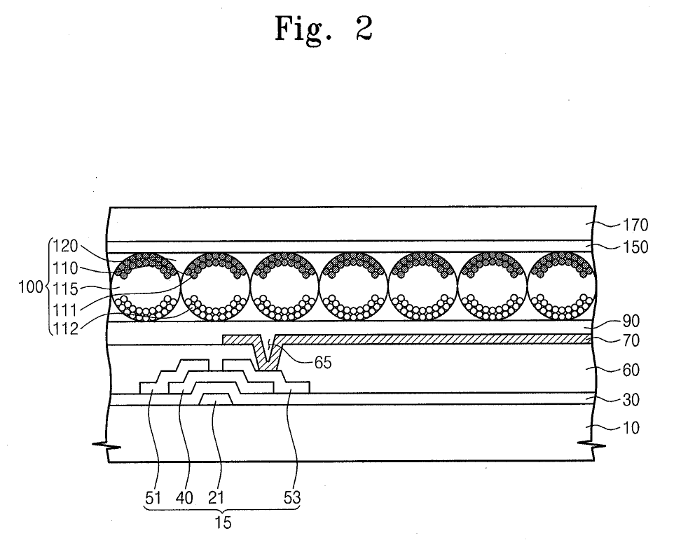

FIG. 1 is a perspective view showing an exemplary embodiment of a flexible reflective display device according to the present invention, and FIG. 2 is a sectional view showing a part of the flexible reflective display device shown in FIG. 1.

As shown in FIGS. 1 and 2, a flexible reflective display device includes a substrate 10, a plurality of gate lines 20, a plurality of date lines 50, a plurality of thin film transistors 15, a protection layer 60, a plurality of pixel electrodes 70, an electrophoretic layer 100, a common electrode 150, and a protection substrate 170.

In the embodiment shown, substrate 10 includes material such as plastic or thin glass having insulating properties and flexibility. The substrate 10 also has a flat-plate shape. The gate line 20 is formed on the substrate 10, and extends in one direction along the substrate 10. The gate line 20 includes metal having low electric resistance, such as aluminum (Al), silver (Ag), copper (Cu), or an alloy thereof. The data line 50 is formed on a plane different from that of the gate line 20 and extends while crossing the gate line 20.

The thin film transistor 15 is formed in an area defined by the gate line 20 and the data line 50. The thin film transistor 15 includes a gate electrode 21, an insulating layer 30, a semiconductor layer 40, a source electrode 51 and a drain electrode 53. The gate electrode 21 is formed on the substrate, and branches from the gate line 20. The gate electrode 21 receives a gate-on voltage or a gate-off voltage through the gate line 20 to turn on or off the thin film transistor 15. The insulating layer 30 is formed on the gate line 20 and the gate electrode 21 to insulate the gate line 20 and the gate electrode 21. The insulating layer 30 can include silicon nitride (SiNₓ) or silicon oxide (SiOₓ).

The semiconductor layer 40 is formed on the insulating layer 30 and overlaps the gate electrode 21. The semiconductor layer 40 includes an active layer and an ohmic contact layer. The active layer forms a channel of the thin film transistor 15. To this end, the active layer can include hydrogenated amorphous silicon. The ohmic contact layer reduces contact resistance between the active layer and the source electrode 51, and between the active layer and the drain electrode 53. In the present exemplary embodiment, the ohmic contact layer may include silicide or amorphous silicon doped with n type impurities.

The source electrode 51 is formed on the insulating layer 30 and the semiconductor layer 40, and branches from the data line 50. The drain electrode 53 is spaced apart from the source electrode 51 by a predetermined distance and disposed in opposition to the source electrode 51.

The protection layer 60 is formed on the insulating layer 30, the semiconductor layer 40, the source electrode 51 and the drain electrode 53 to protect the insulating layer 30, the semiconductor layer 40, the source electrode 51 and the drain electrode 53 from dangers such as external impact. The protection layer 60 may include insulating material. The protection layer 60 includes a contact hole 65 through which a part of the drain electrode 53 is exposed to the outside.

The pixel electrode 70 is electrically connected to an output terminal of the thin film transistor 15. In detail, the pixel electrode 70 is electrically connected to the drain electrode 53 through the contact hole 65. The pixel electrode 70 is a reflective electrode, reflecting light provided from the outside. The pixel electrode 70 can have a black color such that the contrast ratio is improved when a black image is displayed through the electrophoretic layer 100. To this end, the pixel electrode 70 may include carbon nanotubes.

The carbon nanotube has superior flexibility due to its high aspect ratio. In particular, in at least some embodiments, the carbon nanotube has a nano-scale diameter and a micrometer-scale length. In addition, the carbon nanotube typically has high tensile strength and high tensile modulus. For example, the carbon nanotubes can have a tensile modulus of about 640 GPa to about 1 TPa, and tensile strength of about 150 GPa to about 180 GPa.

An adhesive layer 90 is formed on the protection layer 60 and the pixel electrode 70, and an electrophoretic layer 100 is formed thereon. The electrophoretic layer 100 includes a plurality of micro capsules 110 and a binder 120. Each micro capsule 110 includes first electrophoretic particles 111, second electrophoretic particles 112 and an electrophoretic dispersion medium 115. The first electrophoretic particles 111 are charged with a positive polarity and reflect light provided from the outside such that a black color is displayed. The second electrophoretic particles 112 are charged with a negative polarity and reflect light provided from the outside such that a white color is displayed. The charges and colors of the first electrophoretic particles 111 and the second electrophoretic particles 112 may be interchanged. The binder 120 includes a polymer and is filled between the micro capsules 110. The binder 120 has predetermined coupling strength to fix the micro capsules 110.

The common electrode 150 is formed on the electrophoretic layer 100, and generates an electric field in corporation with the pixel electrode 70 such that the first and second electrophoretic particles 111 and 112 can be subject to electrophoretic behavior. The common electrode 150 can include transparent conductive material, so that light reflected from the electrophoretic layer 100 passes through the common electrode 150. For example, the common electrode 150 can include materials such as Indium Tin Oxide (ITO) and Indium Zinc Oxide (IZO).

The protection substrate 170 is formed on the common electrode 150 to protect the common electrode 150 and the electrophoretic layer 100. The protection substrate 170 can include transparent and flexible materials.

Meanwhile, in the present exemplary embodiment, the electrophoretic layer 100 of the flexible reflective display device can be replaced with one of an elecrochromic device, an electrowetting device and a reverse emulsion electrophoretic device (REE).

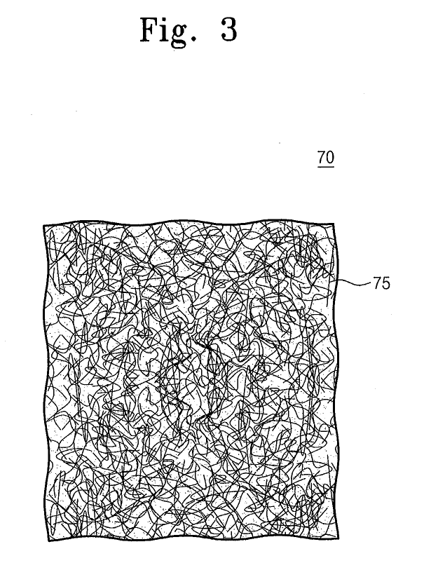

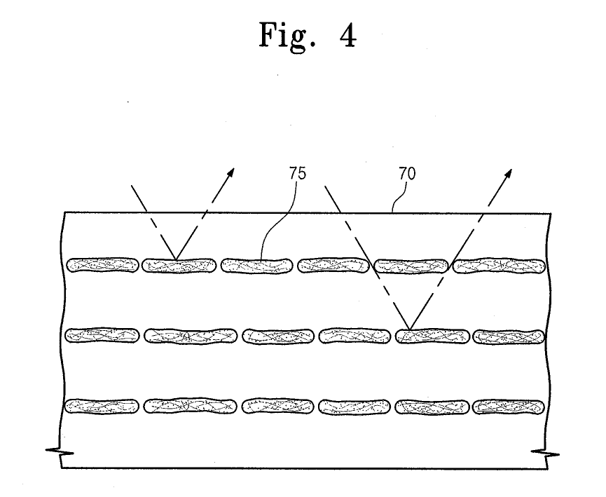

FIG. 3 is a partially-enlarged view showing a part of the pixel electrode shown in FIG. 1, and FIG. 4 is a sectional view showing the pixel electrode shown in FIG. 3. As shown in FIGS. 3 and 4, the pixel electrode 70 includes carbon nanotubes 75. Each carbon nanotube 75 is a fine molecule, which has a diameter of approximately 1 nanometer with a long tube shape in which carbons are connected in the form of a hexagonal link. The carbon nanotube 75 is fabricated in known fashion, by wrapping a plane of carbon atoms that are bonded to each other in a unit of three atoms to form a honeycomb shape. The carbon nanotube 75 reflects the light provided from the outside such that a black color is displayed.

The carbon nanotubes 75 of the pixel electrode 70 can be connected to each other to form a long, continuous structure, allowing the carbon nanotubes 75 to be packed sufficiently tightly that the pixel electrode 70 is opaque. That is, a long, continuous carbon nanotube 75 can overlap itself in a sufficient number of different locations that it effectively blocks light. The space between the carbon nanotubes 75 is magnified in FIGS. 3 and 4 to facilitate explanation. However, it should be noted that the invention is not limited to the configurations shown. In particular, the invention may include configurations employing both a single (or a small number) of long, continuous carbon nanotubes 75, and a larger number of shorter carbon nanotubes 75, so long as they collectively act to render the pixel electrode 70 sufficiently opaque.

It should also be noted that the pixel electrode 70 can have multiple layers of the carbon nanotubes 75. Such a multi-layer structure can reflect more of the light incident into the pixel electrode 70. That is, the pixel electrode 70 improves reflectivity relative to incident light, especially when multiple layers of carbon nanotubes 75 are employed.

Hereinafter, a contrast ratio of the flexible reflective display device according to the present exemplary embodiment of the present invention will be explained with reference to Table 1.

TABLE 1

| | Reflectivity (%) | | |
|---|---|---|---|
| Class | Black | White | Contrast ratio (CR) |
| Comparative example 1 | 3.9 | 30.7 | 7.9 |
| Comparative example 2 | 3.0 | 28.5 | 9.4 |
| Comparative example 3 | 3.7 | 28.8 | 7.7 |
| Comparative example 4 | 2.8 | 29.7 | 10.5 |
| Comparative example 5 | 3.0 | 30.6 | 10.1 |
| Comparative example 6 | 3.3 | 29.6 | 9.1 |
| Comparative example 7 | 3.1 | 28.1 | 9.2 |
| Comparative example 8 | 3.3 | 34.1 | 10.3 |
| Maximum value | 3.9 | 34.1 | 8.8 |
| Minimum value | 2.8 | 28.1 | 10.0 |
| Average value | 3.3 | 30.1 | 9.2 |
| CNT | 2.2 | 30.1 | 13.6 |

Table 1 compares the reflectivity and the contrast ratio of flexible reflective display device utilizing pixel electrodes (hereinafter, referred to as a first pixel electrode) including IZO, to a flexible reflective display device utilizing pixel electrodes (hereinafter, referred to as a second pixel electrode) with carbon nanotubes. The reflectivity is measured in known manner, through a reflectivity measuring scheme using an integrating sphere. The flexible reflective display devices have the same area and receive external light having the same luminous intensity.

In Table 1, comparative examples 1 to 8 (hereinafter, referred to as a comparative group) represent results for the pixel electrode including IZO, and the CNT represents a result for the pixel electrode with carbon nanotubes. In addition, in Table 1, the maximum value represents the highest measured value in the comparative group, and the minimum value represents the smallest measured value in the comparative group. The average value represents an average of the measured values in the comparison group. Meanwhile, since the electrophoretic particles may not be uniformly distributed over the electrophoretic layer, the comparative examples 1 to 8 represent reflectivities different from each other.

$$C R = \frac{W}{B} \qquad [ EQUATION 1 ]$$

Referring to Equation 1, the contrast ratio represents a ratio of a black color relative to a white color.

As shown in Table 1, when the black color is displayed, the pixel electrode containing CNT (carbon nanotubes) has a reflectivity lower than that of the average value of the comparative group. Since the second pixel electrode includes CNTs, the second pixel electrode is opaque and has low light transmittance. The first pixel electrode has light transmittance higher than that of the second pixel electrode. In addition, the flexible reflective display device utilizing the first pixel electrode displays an image having brightness lower than that of the flexible reflective display device utilizing the second pixel electrode.

CNTs yield a 36% improvement in contrast ratio, relative to the average contrast ratio of the comparative group. Accordingly, the flexible reflective display device including the second pixel electrode can display white and black images more clearly as compared with the flexible reflective display device including the first pixel electrode.

Hereinafter, transmittance and sheet resistance of the flexible reflective display device according to the present exemplary embodiment of the present invention will be explained with reference to Table 2.

TABLE 2

| | | Sheet | | |
|---|---|---|---|---|
| | Transmittance | Resistance | Reflectivity | Contrast |
| Class | (%) | (ohm/sq) | (W, B) (%) | ratio (CR) |
| First CNT | 50 | 54.6 | 42.22, 2.41 | 17 |
| | 30 | 32 | 42.11, 2.48 | 17 |
| | 15 | 15 | 43.92, 2.78 | 16 |
| Second CNT | 70 | 366 | 17.58, 2.36 | 7.4 |
| | 85 | 331 | 22.57, 3.3 | 6.8 |

Table 2 shows the transmittance, sheet resistance, light reflectivity, and contrast ratio for a first flexible reflective display device which has a pixel electrode (hereinafter, referred to as a third pixel electrode) including continuously connected carbon nanotubes, and a second flexible reflective display device which has a pixel electrode (hereinafter, referred to as a fourth pixel electrode) including discontinuously connected carbon nanotubes. The reflectivity is measured in known fashion, through a reflectivity measuring scheme using an integrating sphere. The flexible reflective display devices have the same area and receive external light having the same luminous intensity.

In Table 2, the first CNT represents the third pixel electrode, and the second CNT represents the fourth pixel electrode. Since the carbon nanotubes of the third pixel electrode are continuously connected, a space serving as a path for light may not exist. In contrast, the carbon nanotubes of the fourth pixel electrode are connected to each other in a net shape, so that a plurality of empty spaces serving as paths for light may exist.

The first CNT is measured by using first to third samples having thicknesses different from each other. The sheet resistance and the transmittance vary depending on the thickness of the carbon nanotube layer(s). For example, the first sample (with a transmittance of 50%) has the largest thickness, and the third sample (with a transmittance of 15%) has the smallest thickness. If the sheet resistance exceeds 100 ohm/sq, the driving voltage of the flexible reflective display device increases. Accordingly, the first CNT may preferably have a transmittance of about 50% or below and the sheet resistance of about 100 ohm/sq or below.

The first CNT has a contrast ratio about twice that of the second CNT. The first CNT has a contrast ratio of about 10 to 20. Accordingly, the flexible reflective display device including the first CNT can display black and white images more clearly as compared with the flexible reflective display device including the second CNT.

According to the above, the first electrode including carbon nanotubes continuously connected to each other reflects the external light, so that the contrast ratio may be improved. Therefore, the flexible reflective display device may display clearer images.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A flexible reflective display device comprising:
a substrate;
a thin film transistor provided on the substrate;
a first electrode electrically connected to the thin film transistor and comprising carbon nanotubes that reflect an external light, so as to display a black color;
an electrophoretic layer disposed on the first electrode; and
a second electrode provided on the electrophoretic layer.

2. The flexible reflective display device of claim 1, wherein the carbon nanotubes of the first electrode are continuously connected to each other.

3. The flexible reflective display device of claim 1, wherein the first electrode has a light transmittance of about 0% to about 50% relative to the external light.

4. The flexible reflective display device of claim 2, wherein the first electrode comprises at least one layer of the carbon nanotubes.

5. The flexible reflective display device of claim 2, wherein the first electrode reflects the external light according to a contrast ratio of about 10 to about 20.

6. The flexible reflective display device of claim 2, wherein the first electrode has a sheet resistance of about 0 ohm/sq to about 100 ohm/sq.

7. The flexible reflective display device of claim 1, wherein the first electrode has a tensile modulus of about 640 GPa to about 1 TPa.

8. The flexible reflective display device of claim 1, wherein the first electrode has a tensile strength of about 150 GPa to about 180 GPa.

9. The flexible reflective display device of claim 1, wherein the electrophoretic layer comprises a black electrophoretic particle and a white electrophoretic particle.

10. The flexible reflective display device of claim 1, wherein the substrate comprises a flexible material.

11. The flexible reflective display device of claim 1, further comprising a protection substrate that is provided on the second electrode to protect the second electrode.

12. The flexible reflective display device of claim 1, wherein the thin film transistor comprises a gate electrode, an insulating layer, a semiconductor layer, a source electrode and a drain electrode, and the first electrode is connected to the drain electrode.
